(19) United States
(12) Patent Application Publication
(10) Pub. No.: US 2020/0314178 A1
(43) Pub. Date: Oct. 1, 2020

(54) CAPSULE SYSTEMS AND METHODS

(71) Applicant: MY UNIVERSE LLC, Brooklyn, NY (US)

(72) Inventor: Keith Yokomoto, Brooklyn, NY (US)

(21) Appl. No.: 16/833,518

(22) Filed: Mar. 28, 2020

Related U.S. Application Data
(60) Provisional application No. 62/826,911, filed on Mar. 29, 2019.
(60) Provisional application No. 62/826,896, filed on Mar. 29, 2019.

(51) Int. Cl. H04L 29/08; H04L 29/06; G06F 3/0482; G06F 3/0481

(52) U.S. Cl. CPC H04L 67/1095; H04L 67/02; G06F 3/04817; G06F 3/0482; H04L 67/42

(57) ABSTRACT

A system for storing and managing contacts includes a contact management application installed on a client computing device and configured to store contact data associated with a subject into a contact file. The contact data comprises a first set of data fields compatible with a standard contacts application and a second set of data fields compatible with the contact management application, one or more data fields being respectively associated with a corresponding application capable of operating on the client computing device. The contact management application also provides a visual interface comprising a content area, a contact file selection menu, and an application selection menu, and in response to the selection of the application display associated content from the selected contact file. The contact management application provides a user interface for selecting or inputting content data for storage into the contact file, and the client computing device includes a network connection interface for transmitting a selected contact file.

### CROSS-REFERENCE TO RELATED APPLICATIONS

This application claims the benefit of U.S. Provisional Application 62/826,911, filed Mar. 29, 2019, and U.S. Provisional Application 62/826,896, filed Mar. 29, 2019, the entirety of which are herein incorporated by reference.

### FIELD OF THE INVENTION

Embodiments of the present invention relate to computer technologies. Specifically, embodiments of the present invention relate to improvements in the field of contacts and related features.

### BACKGROUND

Contacts is a well-known feature that is implemented and required for users as part of everyday use of mobile phones and personal computers. Individuals use a software application to receive, save, edit and maintain contacts on their mobile phone or personal computer. For example, on a mobile phone, a contacts mobile application is implemented that is configured to provide access to saved contacts and to send or receive contacts. This can involve individual files that have a structure defined by a standard adopted by a standard setting body. The standard that is almost universally used is VCF format or Virtual Contact File. The contact file includes a structure that is configured to allow an individual to specify their personal contact information and share that with another user in one document. The file can then be received and added to a local database that is the user's combined set of contacts. The contacts software is configured to allow the user to edit the contact file and therefore file information about another person using the contacts software. This file serves a need for an individual to share with another person the details of how the individual can be contacted (communication addresses) and provide some basic information such as their title.

The technology for keeping and managing contacts on computing devices has not significantly evolved over the years and continues to exhibit various deficiencies, which have not been solved in this field or by the use of other technologies. For example, contact files mostly serve as static repositories of text-based data and are for many years limited in the type of content they can store and the functionalities they can provide. Accordingly, improvements in the field of contact and related technology are contemplated that can significantly enhance efficiency, user experience, speed of operation, and Internet techniques.

### SUMMARY OF THE INVENTION

A system for storing and managing contacts is disclosed. The system includes a contact management application installed on a client computing device, the client computing device including a microprocessor and volatile and non-volatile memory to configure the client computing device, the contact management application configured to process a plurality of contact files, and configured to: store contact data associated with a subject into a contact file, the contact data including a first set of data fields compatible with a standard contacts application and a second set of data fields compatible with the contact management application, one or more data fields being respectively associated with a corresponding application capable of operating on the client computing device; and provide a visual interface on the client computing device including a content area, a contact file selection menu for selecting a contact file of the plurality of contact files, and an application selection menu for selecting one of the applications associated with the content of the contact file, and in response the selection of the application display in the content area content associated with corresponding data fields from the selected contact file, wherein the contact management application provides a user interface on the client computing device for selecting or inputting content data into the contact management application for storage into the contact file, and wherein the client computing device further includes a network connection interface that allows the client computing device to communicate with another computer system over a network, and the contact management application is configured to transmit a selected contact file to the other computer system.

In some embodiments, the first set of data fields is compatible with the VCF standard.

In certain embodiments, the contact file is structured to enable standard contact applications to open the contact file to access the first set of data fields.

In some embodiments, the contacts management application is configured to be able to open, edit, and save a standard contact file having a standard contact file structure.

In certain embodiments, the contact file is a dynamic contact file in which the one or more data fields include a link to content stored on a remote server and updates to the stored content are displayed by the selected application.

In some embodiments, the contact management application is configured to select and add a media file to the contact file, the application being configured to upload the selected media file to a server associated with the application, create a link to the location of the uploaded media file on the server, and include the link in the one or more data fields of the contact file.

In certain embodiments, the contact management application generates a modified link for content stored on a remote server, the modified link being configured to include security or personalization data that restricts the content to specific users.

In some embodiments, the contact file can be saved as an icon on a lock screen or home screen of the client computing device and the content of the contact file can be displayed by a general viewer application, the contact file operating as a portal between that provides the general viewer with the content.

A system for storing and managing capsules for content associated with a subject is also disclosed. The system includes a processor configured to acquire computer readable instructions stored in one or more memory devices and execute the instructions to: process content stored in a capsule and related to the subject, the content including sets of identification data and having one or more applications associated with the content; provide a visual interface including a content area configured to display content, a capsule selection menu configured to enable the selection of a capsule, and an associated application selection menu configured to enable the selection of an application; and display in the content area of the interface, selected content associated with a selected one of the capsules and a selected application.

In some embodiments, the visual interface is provided by a capsule management application configured to open the capsule, edit the capsule, and display content from the capsule.

In certain embodiments, the capsule management application is configured to read, display, and edit a standard contacts file and is further configured to convert the standard contact file into a capsule.

In some embodiments, the processor is a processor of a client computing device and the system further including a server in communication with the client computing device over a network and configured to store the content of the capsule.

In certain embodiments, the capsule selection menu and the application selection menus include scrollable menus and scrolling through the capsule selection menu updates the content area with content from the selected capsules associated with the selected application, and scrolling through the application menu updates the content area with the selected applications associated with a selected capsule.

In some embodiments, the capsule includes a data structure, a database entry, or one or more files.

In certain embodiments, the capsule includes a section that can be read and edited by a standard contacts application.

In some embodiments, the content further includes documents, media, or links to documents and media and the one or more applications are configured to open the documents, media, or links.

In certain embodiments, the processor is further configured to execute the instructions to transmit a copy of the capsule to another computer system over a network, and before transmission to restrict access to the content of the transmitted capsule on the other computer system to certain of the one or more applications associated with the content.

A method for storing and managing capsules is also disclosed. The method includes processing content stored in a capsule and related to the subject, the content including sets of identification data and having one or more applications associated with the content; providing a visual interface including a content area configured to display content, a capsule selection menu configured to enable the selection of a capsule, and an associated application selection menu configured to enable the selection of an application; and displaying in the content area of the interface, selected content associated with a selected one of the capsules and a selected application.

In some embodiments, the capsule selection menu and the application selection menus include scrollable menus and scrolling through the capsule selection menu updates the content area with content from the selected capsules associated with the selected application, and scrolling through the application menu updates the content area with the selected applications associated with a selected capsule.

In certain embodiments, the capsule includes a section that can be read and edited by a standard contacts application.

A public contact directory system is also disclosed. The system includes a server that is configured to be accessible to the public via the Internet or other network connections and is configured to store contact files for individuals or other objects and is configured to allow individuals to download individual contact files to client devices for their use and editing on their computer and is configured for contact files on the server to be claimed or verified by the individual that is the subject of the contact file, wherein the server is further configured to communicate with the client devices to modify access to and the content of the downloaded contact files.

### BRIEF DESCRIPTION OF THE DRAWINGS

Various advantages and features of the invention will be understood from the following detailed description taken in connection with the appended claims and with reference to the attached drawing figures in which:

FIG. 1 illustrates a representation of a contact file or capsule according to an embodiment of the present invention.

FIG. 2 illustrates an exemplary computing device for storing and managing contact files, according to an embodiment of the present invention.

FIG. 3 illustrates an exemplary display screen of a main interface or visual interface for a capsule application on a mobile device according to an embodiment of the present invention.

FIG. 4 illustrates a diagram of an exemplary system for managing contact files or capsules according to an embodiment of the present invention.

FIG. 5 illustrates an exemplary user interface for creating a capsule according to an embodiment of the present invention.

FIG. 6 illustrates a representation of an online contact directory and delivery service according to an embodiment of the present invention.

### DETAILED DESCRIPTION OF THE INVENTION

The inventions of the present application relate to making significant advances in the field of contact applications and in a broader sense relates to significant improvements to the general approach and use of current technology and applications. As mentioned above, contact applications are known and have existed for many years without significant improvement. This generally is the world of a person's electronic contact book or address book. Embodiments of the present invention provides improved contact management applications (and systems and methods) that greatly change the approach by using individual and combinations of improvement. The application can be supported and implemented with a contact data structure. An electronic capsule or capsule is used herein to refer to an individual collection of contact materials that are selected and saved under the data structure of the enhanced contact management application as a type of electronic contact file, a contact message (a messaging tool), and/or an electronic structured contact element that delivers new contact materials (after it received by a recipient of the contact through the contact application and its “live” contact such as links to social media). The application is configured to provide the user with flexibility to define and store an electronic capsule with configured predefined data fields that correspond to a range of information, text, content, links, media, or updates. The application can provide interactive functionality through a user interface and underlying data structure to easily create one or more capsules and to send capsules. The application and structure is configured to be static or dynamic in that the content of the capsule can change automatically after it is received and saved in their contact management application by way of an interface that can provide automated linked access to that capsule object's current content on their social media account that are part of the capsule or by being able to provide by transmitting material that is automatically added to the capsule at the recipient (or at a server that provides the contact services). This can bring to life an entirely new world and experience that is not currently available and not tethered or captive to a particular service application such as a social media application.

The contact management application can be configured to have a significantly improved interface that provides better engagement and reduced computer resources. The provided interface can include a structure where there is a window that is displayed above (or below or adjacent) a set of icons that can be scrolled to be in an active subwindow. The display is configured to have the icons correspond to different data fields and corresponding data in the fields in the data structure and/or contact management application. The application is configured to allow the user to move an icon to the active subwindow which will automatically result in the material or content from that icon (e.g., a particular social media account from a social media application) be displayed in the window. This structure provides a convenient approach for a “universal” approach to a contact or capsule. One simply scrolls through icons for that person or object to easily view and quickly review different material for that person or object such a music group, This can reduce the system and application fragmentation of current systems that is created by the trend towards having individual software applications. For example, the preset icons can be electronically set for different social media application (e.g., with an API) or they can connect to cloud based version of that service without relying on a local application. This approach has many advantages technically and otherwise. For example, a music band can define a capsule with their Instagram, Facebook, Snap, home website, photographs, news, and chat, and can send the capsule or can save the capsule as a public capsule for fans to save for themselves. The capsule provides a comprehensive live dynamic and virtual tool (through a single point such as a capsule icon in the contact application or an icon for the capsule file in the computer system) that makes the experience more engaging and delivers information efficiently. As another example, an on-demand car service company can define a capsule and the user can save and use the defined capsule for their use. In this respect, the application can provide the user through the structure and interface the ability to call a vehicle using web based version of their service when the icon in the interface is positioned at the active subwindow. The other icons would provide other contact information, media, or other access for that service. By using the web based service, there is less of a need to save and store individual mobile applications, although as noted above, that can be an option. The web based service can incorporate automated login.

Another advantage is the ease that the interface permits capsules to be prepared in that a band can use the integrated interfaces to quickly select material to include in the capsule for a tour (for example) and distribute that to their massive fan base and can further quickly update that capsule once defined. As can be seen, in another aspect, an advanced configured contact messaging system is developed that provides a new “vivid” approach to allow a user to define a capsule for a particular object and to distribute that by storing the capsule for public access and use. This messaging is preconfigured and provide an efficient message distribution tool.

Embodiments of the present invention disclose an enhanced contact system that provide a new approach for the contact file (e.g., the structure and related aspects). The system can define a contact file that includes a plurality of sections. The contact file includes a configured structure that stores in associated structured fields “traditional contact” information such as the communication addresses (e.g., telephone number, email address, and mailing address) of the object of the contact. The structures filed can also store links to links to the object's personal social media accounts on a social media platform (such as Facebook, Linkedin, or Instagram). The data structure can include links to the object's personal website. It can include links to that object's personal Venmo, Paypal, or other financial payments or transmission network. The data structure is also configured to include specific structure and associated data field for other, “non-traditional” contact content that further enhances the card. In particular, the additional fields and structure of the contact file or card work in combination with contact management software configured to read and display the content of the card to provide on a client computing device an enhanced platform and method of presenting and interacting with content associated with the object of the contact. The structure can also include links to documents (e.g., PDFs), or media such as an image, audio, or video that is provided in the contact file as a link and is accessible through a server when selected or such the contact file can be structured to have such documents and multimedia as an attachment. The number of files associated with the data structure is only limited by the available storage and computing resources.

Embodiments of the present invention also disclose systems, method, or computer readable media (which for convenience be referred to as system) to implement an online contact directory and delivery service. In general, it should be understood that the service involves one or more servers (e.g., such as a cloud comprising servers and supporting infrastructure). A software application (in non-transitory medium) is implemented on the service to configure the service to provide features and functionality described herein. The service can be accessible through a conventional web browser or through an application such as mobile applications that are loaded on mobile devices.

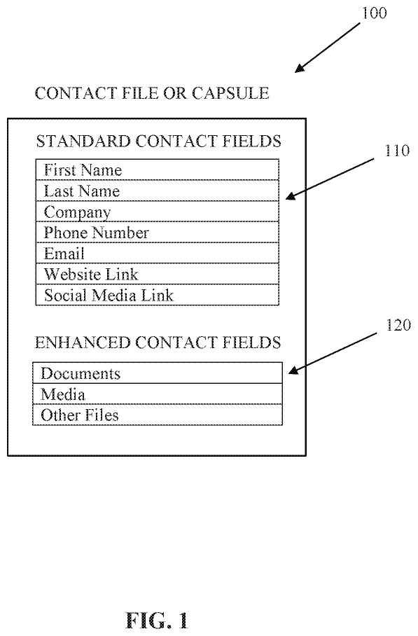

FIG. 1 illustrates a representation of a contact file or capsule 100 according to an embodiment of the present invention. The contact file or capsule 100 can have two sections: a first section 110 that is specifically configured to be compliant to an existing contacts standard and a second section 120 that includes additional features that are not covered by the standard or are not compliant with the standard. The section 110 of the contact file or data structure that is directly compliant with an existing contacts standard may be compatible with the VCF standard in some embodiments. This means that the data structure fields 110 and data structure include portions that can be read and interpreted under the standard such that an existing contacts application that is compatible with the standard can receive, read, and correctly associate the value provided for that field with the appropriate field under that standard. The contact file 100 can thus be structured to allow conventional contacts applications (e.g., the contact mobile app on an Apple phone, or contacts in MS Outlook) to open the contact file 100 and view information about the object of that contact in that application and in particular view the information or values that are stored in the contact file 100 in compliance with the standard. One technique for implementation is the ability to convert the contact file of embodiments of the present invention (which may already contain the standardized field and values) to a contact file that would be recognized or be formatted to be recognized as a standard contact file. Other implementations are contemplated. For example, the non-standard data in the contact file can have an associated tag or location in the file such that a standard contacts application would not respond to it with an error. In some embodiments, the non-standard data in the contact file may feature an associated tag under the standard that would allow the non-standard data to be in the file without negatively disrupting or interfering with the standard contacts application's access to the standard contact data in the file.

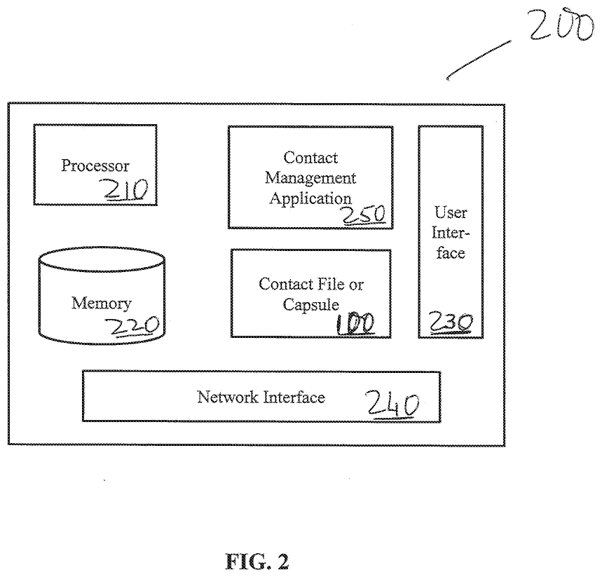

FIG. 2 illustrates an exemplary computing device 200 for storing and managing contact files 100, according to an embodiment of the present invention. The computing device 200 can include a processor 210 and volatile and/or non-volatile memory 220 to configure the computing device 200. The computing device 200 further includes a user interface 230 that enables a user to provide input to the computing device 200. The computing device also includes a network connection interface 240 that allows the computer system to communicate with another computer system over a network. Typically, the computing device 200 is a mobile smartphone that is handheld and capable of downloading and installing mobile applications that can communicate through the mobile phone with a server via mobile networks or other wireless networks.

A contact application or a contact management application 250 is installed to the computing device 200. The contact application 250 in this disclosure is a software application program of a type that is directed to receiving, creating, editing, managing, and searching contacts (that user's contacts and that user's own contact information in a personal contact) and that enables the user to easily store and find contact information, such as names, addresses and telephone numbers and includes or uses a contact-centric database. The program can be part of another application or module. The contact file 100 of embodiments of the present invention can be compatible with a contact application 250 that is configured to exercise the standardized section 110 and non-standard or enhanced section 120, and to provide access to the contact information in the contact file 100 through a graphical user interface that presents the information in accordance with the data field and structure. For example, the contact application 250 can open a contact file 100 having a file extension for standardized or known contact files, and may be configured to appropriately recognize all the contact information 110 (e.g., association of value with corresponding data fields for that category of information) in the contact file 100 because the application is compatible with the structure. The contact application 250 is further configured to enable the user that opened the contact to make changes to the contact by editing the information and saving the contact (with the contact's data structure and file reflecting the changes). The update can be saved to the user's standard contact database on their device (which can include storage on a cloud as a form of additional personal storage for that person's contacts).

The contact application 250 is configured to allow the user of device 200 to create, modify, or update their own contact file 100. The contact application 250 in conjunction with the contact file 100 provides the user with a visual interface that allows the user to select and add communications addresses for themselves as well as personal feeds or channels. This can significantly enhance the utility use and efficiency. The application 250 and data structure 100 includes sections for the user to include one and preferably multiple feeds such the contact owner's website, Facebook account, Instagram account, and YouTube. This allows a static way for the contact owner to create a dynamic contact file. The structure of the contact file 100 can be configured to receive and store the appropriate links for the different feeds and channels. The contact file 100 can be shared (e.g. by being transmitted) to another person and the recipient can open the contact and select a feed that is directly linked (or indirectly linked) to the sender's channel or feed. The contact application 250 and contact file 100 can be configured to cooperatively allow for the contact creator to include media such a photos or video to the contact file. The contact application 250 can provide the user with an interface to select the addition of media to the contact, such as an introduction video. The application 250 further provides the user the option to select a video from their device's library of such content or other location to which the contacts application may have access. The application 250 and file 100 can be configured to electronically include or attach the media to the contact file. The application 250 and file 100 can be configured to, when the user selects media to attach, upload the media to a server (associated with the application), create a link to the location of that media on the server and include the link in the creator's contact file. The link to the media provided to the user's contact file by the application may also be shared with recipients of the contact file shared by the user.

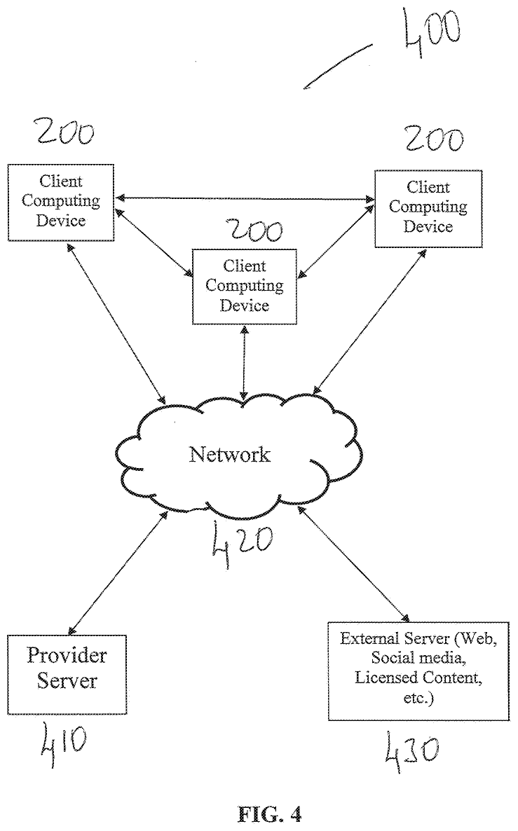

The links discussed above can be used to incorporate permission or personalization with respect to the content accessed by exercising the link. For example, an application such as the contact application 250 can modify or create links using the links or details for accessing a website, channel, feed, or suite of resources. The modified or created link is included in the contact file 100 as the link for accessing content that the owner of the contact has chosen to make available to others via the contact. The modified or created link can be configured to include security or personalization data such as a security token, an identification, password, or encrypted identifier. When the link is selected from a contact that is displayed, the security or personalization data in the link (or associated with the transmission of the link and related communications) is transmitted to the source of the contact (e.g., a third party service such as Google Docs or Facebook) where the security or personalization data is extracted and used by a computer at the source to determine security credentials or personalization features. For example, the recipient computer at the source of the contact may determine whether the user who selected the link has permission (based on contact owner's permission settings on that third party site) to access the linked content; the computer at the source of the contact may also determine information about the user who selected the link and vary the content that is delivered in response based on the user (or other criteria). In some embodiments, some or all links are configured to operate through a server or online service, such as illustrated in FIG. 4, discussed further in this disclosure. Referring to FIG. 4, the server or online service 410 may provide the contact structure and contact application and the server or online service 410 may exercise the link to the content. The content can be delivered through the server or online service 410 or directly to the device 200 used (by a user) to select the link. The source in conjunction with the server or online service 410 can be configured to determine based on the link (and potentially related information that is transmitted to the source in connection with exercising the link) that the link was exercised through server or online service 410, and if it is not operating through that server or online service 410, the source can block the request and not provide the linked content. Other techniques are contemplated in conjunction or alternative to this approach such as the security or personalization data being communicated or involved in an exchange that is subsequent to the transmission of the link but closely associated in timing (for example by executable rules in contact file, contact application, or server/online service). Another technique being contemplated is to encrypt the contact tile comprising media and to move the file from a central server to a cloud service or a local device storage accessible by the user.

The contact application 250 can be configured to store personal information about the user of the mobile device and use (e.g., transmit) that information in connection with the user seeking to view content from a contact card 100. For example, a company may have created a contact file 100 and provided the contact file 100 to a user. The user can open the contact on their contact application 250 that is configured to appropriately display and provide field positions for the values in the contact file. The user can select to view a contact and then select to access a link in that contact for a document on an online application such as a set of documents stored in the cloud application. In response, the contact application 250 can transmit the user's email address in conjunction with the user selecting to view the document and the email address is provided to the site. The email address is used to determine whether the user has authorization (e.g., may also require the user to enter a password on the cloud application) or which content the creator of the documents has made available to that user based on the email address.

In some embodiments, the contact application 250, contact file 100, or combination thereof provide a preconfigured structure that specifies the display arrangement of the contact to the user application (e.g., viewer, contact application 250) of the mobile device 200. The contact using the contact file 100 can be displayed in a contact application 250 that is configured to be compatible with the present embodiments of the present invention. The contact application 250 can be configured to include a graphical interface that is used for displaying contacts in the contact application 250 and is configured to have a particular graphical arrangement for presenting and exploring the content as illustrated further in this disclosure. The contact can also be displayed in a browser such as a conventional browser because for example. The contact file 100 is configured to have a structure that is compatible for opening in a browser and when opened the contact file includes characteristics that instruct the browser to the display graphical elements that are used for presenting contacts such as box, windows, or icons that are configured to present the contact in a particular preconfigured way (e.g., such as those illustrated herein). The contact file 100 can have instructions or parameters specifying visual elements (and relationship), which is not referring to simply displaying text that is in the contact file using a browser. The graphical user interface for displaying contacts as part of the service can be displayed by a server using information in the contact file such as by transmitting a web page to the device of user when a user opens a contact file on their device (e.g., double clicks a saved contact file). The interface is configured to be a standard layout that is used for displaying contacts (e.g., is repeatedly displayed in the same way so that the user gains quick understanding). Structural variations in the way it is displayed from contact to contact can cause the user confusion or increase the time to comprehend content which can affect use and engagement negatively.

In some embodiments, the contact file 100 can be saved on desktop 200 or on the application screens of a mobile device 200. For example, the device 200 can open a contact file and the graphical user interface for the card can be displayed by the device (e.g., using solely the information in the card and a generic viewer app such as a conventional browser, or using a viewer app such as a conventional browser that relies on external sources using links in the contact file 100 to display the contact graphical user interface on the screen of the mobile device 200). The mobile device 200 can allow the user to save the contact file 100 on the home screen or lock screen (for example), which will then save it as an icon on the home screen or lock screen. This can be similarly implemented in other devices such as a personal computer 200. The contact file 100 may then be displayed to the user in a similar manner to other apps and may be a mere data file, an executable software application, or other format capable of being displayed to a user for direct access by the operating system of the device (e.g., on a desktop or home screen). The user of the mobile device 200 would not need to load an application to be able to use the contact file because in this example it can be opened using a general viewer application such as a conventional browser. This can reduce the need to download an app or have sufficient memory on the device 200 to load an app to view the contact file. The contact file 100 when selected can be configured to operate as a portal that provides for example, a primary window for viewing content available for the object of that contact file 100 from sources such as social media sites or website. A window that is displayed in the graphical user interface can be configured to directly (e.g., using an API) or indirectly (e.g., through the contact service's server) to request, retrieve and display in a main window in the interface content from a particular source when that source is selected for viewing in the window in the graphical user interface. The saved contact file 100 may thus operate as a portal for integrating various content by viewing one of the sources in the main window of the interface. The contact file 100 further can potentially avoid the need for downloading or using multiple local software application because the source of the content often times include an online application that delivers the same content without the need for a local application (such as a local mobile application). This can increase the available functionality on the device 200 and speed up device operation because of lower local processing overhead and software applications.

In some embodiments, the contact file 100 or contact application 250 use application program interfaces to connect with applications on the device 200 or on a server to be able to deliver the content in the displayed contact.

The configuration of contact file 100 and/or contact application 250 can provide a consistent and reliable graphical presentation of content for an object. In the music industry, for example, there are many sources and sites where entertainers publish information and content including their own websites. Such websites can be time consuming and difficult to maintain for an entertainer or others. Embodiments of the present invention can avoid this overhead cost allowing the creation and display of the desired content and information in the graphical user interface for contacts (as illustratively described herein). Embodiments also tackle a fracturing of Internet resources by integrating the resources into a single contact interface where information or content from separate and distinct resources (e.g., Facebook versus Instagram) can be available through one user interface for a particular person or object. This can provide an advancement in Internet technology that for example avoids the need to leave and enter different application to receive desired content, by the embodiments providing a structure and application that integrates the resources together. This provides higher level of use and efficiency. Embodiments can also permit the recipient contacts of the present invention to edit that contact file and add their own information or values (e.g., add their image of an artist from their phone to be part of the contact file).

The contact file 100 can also represent an advancement over the inclusion of multiple links in emails or website for an object of the email or website. It is very common for websites, for example, to include a Facebook, Instagram, Twitter, and other links to their accounts. This can be the same in emails. The contact file 100 provides a method where those icons and links can be replaced by the contact file icon for that that object. This allows the system to receive the contact file 100 as an object that is downloaded and can be saved such as in the contact application 250 and the contact file 100 includes the links for current and future access to the object's feeds from those services and others. The attachment can provide a quicker and more efficient way to access those links and reduce the content or websites and emails.

In embodiments of the present invention, the contact file 100 is selectively created and modified by a user deciding using an interface what information such as links, address, or content to include in the contact file 100. In some embodiments, content may be automatically collected about a user to create or modify a contact file for an object (e.g., an individual that is the subject of the contact file). In such embodiments, a computer may automatically collect information about a subject and automatically store it in the contact file. For example, a client computing device may use the features of an application to aggregate information about the subject on the device such as all of that contact entails or documents. In some embodiments, the contact applications 250 on client computing devices 200 or servers may enable the addition of content from search results (or linked therefrom) to the contact file 100. For example, the application 250 may offer the option to search the web for the title or object of the contact file (e.g., use the title as a search term) and further display to the user a list of search results and enable the selection of each result for addition to the contact file. The applications 250 may also offer the option to perform freestyle searches by providing a search box, and provide interface elements to add content associated with relevant search results to the contact file (e.g., a link to a YouTube video or the video itself).

Embodiments of the present invention can provide a distributed and un-tethered implementation. For example, the implementation may be without the need or inclusion of a server that is designated to store or interface with the contact file 100 and contact application 250. The contact file 100 and contact applications 250 can operate in conjunction with third party services (e.g., social media accounts) to provide features and therefore, there is no need for a server or site for displaying or storing contacts. There can be other options such as semi-tethered that for example could involve periodic verification of the contact application or contact files using a server associated with the contact application.

In some embodiments, the system includes a server (which is generally understood to include one or more servers or a server that provide a cloud service or application) that includes features for authenticating or verifying contact files 100. A contact file 100 can be stored on the sever and the server is configured to include a verification code that is included in the contact tile. The verification code can be a digital key that is checked (e.g., retrieved) when a user on a mobile device opens a contact file 100 (e.g., in a browser or contact application) and determines whether the contact file 100 is authentic (e.g., one that was distributed by the service/server). The check can be based on a security check that can relatedly verify that the content of the contact file 100 is accurate or has not been tampered with. The server can then transmit a message or signal to the user that confirm that the contact file is valid, which may result in the device 200 displaying a verification notification or “tampered” notification to the user. In response, the server can block the use of the contact file (e.g., the use of its links) when the digital key is not confirmed or verified.

As described above, the contact file 100 managed by contact application 250 installed on computing device 200 may be part of a system 400 for contact management that includes a server in communication with the client device 200, and may include one or more additional client devices 200. FIG. 4 illustrates a diagram of an exemplary system 400 for managing contact files or capsules according to an embodiment of the present invention. The system 400 of the present invention may comprise one or more client computing devices 200 and one or more provider servers 410. The provider server 410 is one or more servers configured to provide and manage services related to the contact file 100 of the present invention. The provider server 410 is in communication with a communication network 420 via one or more communication links. The communications links may be wired and may include optic fibers, Ethernet cables, twisted pair cables, coaxial cables, telecommunications lines, or similar wired protocols. The communication link may also be wireless, such as through local computer networks, e.g., IEEE 802.11 (WLAN), IEEE 802.15 (WPAN), and IEEE 802.15.4 (LR-WPAN), radio frequency systems, e.g., 900 MHz, 1.4 GHz, and 5.6 GHz communication systems, infrared, GSM, GSM plus EDGE, CDMA, quadband, and other cellular protocols.

The communication network 420 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. Although FIG. 4 represents the communication network as a single network, the network can include multiple interconnected networks listed above.

Client computing devices (e.g., mobile phones) 200 may be in communication with the provider server 410 via the communication network 420. The communication link between the client computing devices 200 and the communication network 420 may be wireless or wired, as described above. For example, in a typical embodiment where the client computing devices 200 are mobile phones, the communication link to the network is wireless over a cellular network or WLAN network. Communication may also be established directly between client computing devices (i.e., a peer to peer communication that does not go through an intermediary network). Such communication links may be established to share a contact file 100 or sections of a contact file with another client computing device 200.

The communication between devices 200 that are in proximity to each other could be direct through nearby communication mechanisms such as Bluetooth, near field communication, sound signals, or visual exchange of information.

In addition to the communication links between the provider server 410 and client computing devices 200, the provider server 410 may also be in communication via the network 420 with external services hosted on external servers 430 that are also in communication with the network 420. The external services 430 may be websites, social media networks, or databases from which content of the contact files 100 may be sourced.

The contact file 100 of embodiments of the present invention may also be a multimedia container or an electronic capsule about an object or a subject. In this regard, the multimedia container or capsule 100 of embodiments of the present invention is configured to store, manage, and communicate content related to an entity of interest. The capsule 100 may be configured (in conjunction with related applications) to store, manage, and communicate content on a computing device 200 such as personal computers or mobile devices. An entity of interest or subject associated with the capsule 100 may be a person, and organization, a business, a government, a place, a musical group, a product, a computer, a character, an event, etc.

A capsule 100 may comprise a data structure such as an object configured to store and manage data related to the entity of interest or subject. The capsule 100 may be stored as a data structure, database entry, or one or more files on, and accessed with, a computing device 200. Exemplary computing devices 200 include personal computers, servers, mobile devices, etc. Preferably, each capsule 100 or contact file about an object is a discrete and distinct file stored on or more computing devices 200. The computing devices 200 may comprise capsule applications 250 configured to interact with the capsule 100. The capsule applications 250 may comprise one or more interfaces to enable the user to interface with a capsule 100.

The capsule 100 also may be stored as a data structure, database entry, or one or more files on a server 410. In some embodiments, the capsule 100 may be stored in JSON format. The server 410 may be in communication with the computing devices 200 of users over a network 420 such as the Internet. When a user accesses a capsule 100 on a client computing device 200, the client computing device 200 may transmit a request for capsule data to the server 410. The server 410 may deliver the requested capsule 100 data to the client computing device 200. The JSON format allows capsule data to be accessed from a variety of client computing platforms and be easily distributed between servers. Additionally, the capsule on the client computing device 200 may be synchronized with the capsule information on the server 310 such that changes made to the capsule data on the client computing device 200 are transmitted to the server's copy of the capsule 100.

In some embodiments, the capsule 100 may be platform-agnostic. In these embodiments, the capsule 100 may require an application 250 for access and may only be interacted with within the application 250. In other embodiments, the capsule 100 may be accessed from the operating system and be integrated there within, independently from an application 250. The capsule may be restricted to a specific operating system (e.g., iOS) or operate across operating systems.

A capsule 100 may be presented to a user as a contact in a client computing device 200. This is because a capsule 100 may contain a section 110 that is compatible with and capable of being read and written to by a traditional contacts application. In some embodiments, the capsule 100 may be integrated into the contact application of the client computing device 200. In particular, the capsule may be configured to be treated as a contact by the operating system of the client computing device 200, such that the subject of the capsule appears among the listed contact of a standard contacts application of the client computing device 200. This may be the case for example in embodiments where capsule 100 is saved as a file having an extension compatible with traditional contacts applications (e.g., .vcf extension), along with a compatible section (e.g., a vCard). In some embodiments, capsules listed by a Contacts application may appear in a separate section of the application (e.g., a separate tab).

In an exemplary embodiment, both contacts of the client computing device 200 and capsules 100 may be managed by the capsule management application 250. In these embodiments, the capsule management application 250 may display capsules 100 to the user as contacts, augmented contacts or improved contacts for each subject. The capsule management application 250 may interact with the operating system of the client computing device 200 e.g., through APIs in order to retrieve contact information for display and management in the capsule application 250. In this application, data from each contact may be integrated in the capsule for each contact or subject, such that contacts on the client computing device are managed as capsules 100. Unlike regular contacts however, the client management application 250 enables the user to add any type of data to the capsule for each subject.

The capsule or contact file 100 may be owned by a single user at time. Typically, the owner of the capsule 100 may be the subject of the capsule (i.e., the entity of interest whose information is stored and managed by the capsule). However, the capsule 100 may be owned by an entity other than the subject of the capsule; for example, a default capsule 100 may be created and owned by its creator before it is claimed by the subject of the capsule. Ownership may be transferred to another user. The owner of the capsule 100 may define access parameters for the capsule. For example, the owner may enable access to every user, or may restrict access to a user, group of users, or classes of users. User access may also be restricted by function. For example, users may have read-only or read or write access. Access may also be restricted to specific aspects of the capsule 100. For example, access may be limited to certain applications. Combinations of access restrictions may also be set by the user.

Operation of the capsule 100 will be described in relation to a mobile application configured to manage the capsule (contacts management application or capsule application 250). In this example, the capsule 100 may be a proprietary file that requires the capsule application 250 for access. The capsule application 250 when opened may provide a display window that prompt the user for authentication credentials such as a username and password, passcode, biometric authentication (e.g., Face ID, fingerprints, iris scan, etc.) before displaying the main interface. The capsule application 250 may then engage in an authentication process with a server or within the application before allowing the user access to the main interface.

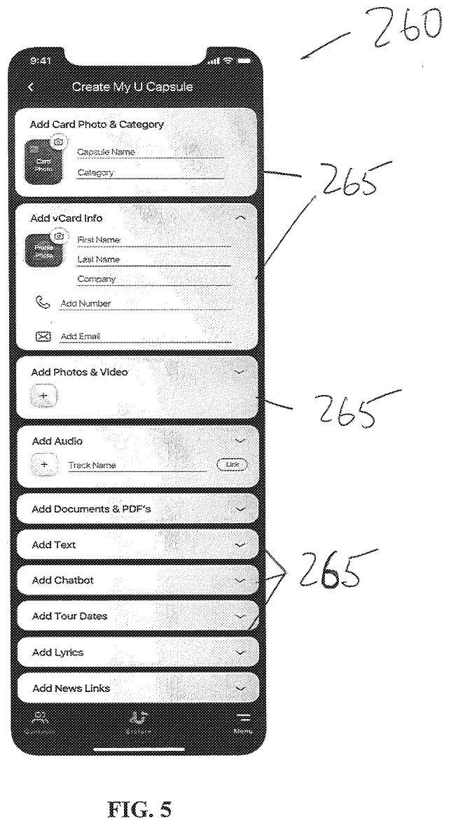

A capsule 100 may be created by a user on a client computing device 200. Typically, a capsule application 250 is required to create a capsule. The capsule application 250 may thus provide an interface for creating a capsule (e.g., My Universe app). However, the same or similar menu may be accessed in other embodiments of the invention where a capsule 100 may be accessed and managed independently of any application. FIG. 5 illustrates an exemplary user interface 260 for creating a capsule according to an embodiment of the present invention. The capsule creation menu or user interface 260 shows and prompts the user for information that may be stored in and managed by the capsule 100. The information to be entered into or captured by the capsule 100 may be organized in several sections 265. The sections 265 may be indicated with particular visual interface elements that illustrate the grouping or related information. For example, each section 265 of the illustrated capsule may be enclosed in a box with rounded edges having a color that contrasts against the background of the capsule creation interface. Exemplary sections 265 displayed by the capsule creation interface include: Card Photo & Category, vCard info, Photos and Videos, Audio, Documents and PDFs, Text, Chatbot, Tour Dates, Lyrics, or New Links. The user may enter information in the corresponding sections. Information to be entered by include text, pictures, videos, links, documents, instant messaging links, apps, payments methods, etc. Information received by the capsule 100 may also comprise other data structures or objects such as vCards. Information can be automatically added to a contact. For example, a user of a device 200 may select an item such as email address and use an option to create a capsule 100 for that email address, and the application 250 may automatically add or insert the email address in the capsule 100.

A capsule 100 may also be created by an entity other than the subject of the capsule. For example, a service associated with the capsule mobile application 250 may create and manage a capsule 100 for a celebrity or a band. Such a capsule 100 is called a default capsule, and may be created using the same mobile application 250 that a subject may use. Alternatively, the default capsule may be created using an application configured for backend operation and that is unavailable to consumers. The default capsule may be populated with publicly available information about the subject. For example, a default capsule for an entertainment group may be created and content such as photos and videos may be downloaded from the internet and input into the capsule creation window. Links to the group's Facebook, Instagram, and other social media accounts on external services 430 may be provided, as well as links to the group's webpage. The default capsule may be claimed by the subject, at which point ownership may be transferred to the subject after the subject identity is verified. Each newly created capsule is assigned a unique ID.

Default capsules may be populated by automated applications or processes residing servers 410. Server applications may extract a subject's data via APIs provided by various services 430 that may contain the subject's data. This includes social media services, and other publicly accessible services through APIs or public information accessible through standard internet protocols, etc. Server applications may automatically retrieve other information relevant to a subject from the Web or other publicly available sources 430. In some embodiments, default capsules may be created for every notable subject with a significant social media presence (e.g., with a blue checkmark on Twitter), for example.

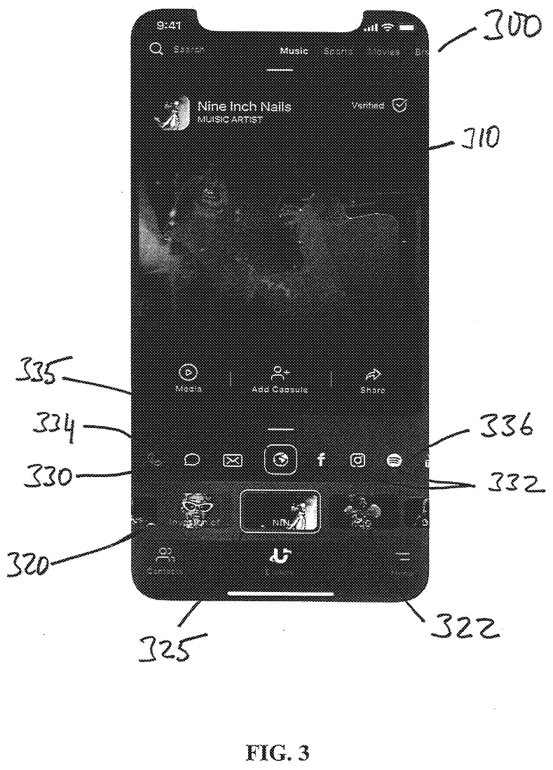

FIG. 3 illustrates an exemplary display screen of a main interface or visual interface 300 for a capsule application 250 on a mobile device 200. The main interface 300 of the capsule application 250 comprises several windows or areas that are directed to different aspects of capsule management. The windows provide interactive features that allow user a user to interact with the mobile device's input peripherals such as gesture-controlled mobile phone interfaces and/or display screen of the mobile phone 200. The visual interface 300 or main interface 300 for visualizing a capsule 100 or contact may principally comprise a main window or content window 310, capsule menu bar or capsule selection bar 320, and an application menu bar or application selection bar 330. The capsule selection bar 320 displays a menu of available capsules, each represented by an icon or thumbnail 322 for a capsule. The capsule selection bar may consist of a scrollable horizontal bar of thumbnails 322. In some embodiments, the capsule election menu 320 may be a carousel menu, or any other type of menu that enables scrolling through thumbnails 322. The capsule selection bar further comprises a selection box 325, typically located at the center of the capsule selection bar 330. To select a specific capsule, a horizontal swipe gesture may be used to scroll through the capsule selection bar 320 (left or right) and place the corresponding thumbnails 322 into the selection box 325. When a capsule is thus selected, the mobile application displays content of the capsule in the content window 310 of the main interface 300. The content window 310 is updated to reflect each capsule that is placed in the capsule selection box 325 during scrolling of the capsule selection bar 320.

The main interface or visual interface 300 of the capsule management application 250 further comprises an application selection bar 330. In the embodiment illustrated, the application selection bar 330 is a horizontal menu bar located above the capsule selection bar 320 and below the content window 310 on the main interface. The application selection bar 330 serves to select and/or activate a function or application of the capsule 100 selected with the capsule selection bar 320. As with the capsule selection bar 320, the application selection bar 330 comprises a scrollable menu, but this time of applications and functions related to a capsule 100. The application selection bar 330 further comprises an application selection box 335, also located in the center of the application selection bar 330 (as with the capsule selection menu 325; in the embodiment illustrated, both selection box 325, 335 are vertically aligned on the main interface 300). In some embodiments, such as illustrated in FIG. 3, the application selection bar comprises a persistent portion that does not vary with application selection bar is actuated, but instead displays a persistent suite of icons. In the embodiment illustrated, the persistent menu 335 comprises the left half of the application selection menu 330, where it is separated from the scrollable half 336 of the application selection menu 330 by the application selection box 335. The icons displayed by the persistent selection bar 335 typically represent the most common functions or important functions of the capsule application 250, or functions for which is most desirable to provide immediate access to the user. In the embodiment illustrated, the persistent icons include a call, chat, and messaging applications or icons. The visual interface 300 is configured to allow the user to interact with icons for sources of the object displayed in the scrollable half 336 of the application selection bar 330. The interface moves an icon into the selection box 335 by scrolling the icons 332 left or right.

The application selection bar 330 enables the user to activate a variety of applications and functions related to a capsule without leaving the main interface screen 300. The combination of capsule selection bar 320 and application selection bar 325 further allows the user to enable the same function in successive capsules (which can be scrolled through using the adjacent capsule selection bar 320) while remaining on the main interface screen 300, where the content corresponding to icon selected in the application selection box 335 is displayed on the content window 210. Thus, for example, a user may scroll through the Instagram profiles of multiple capsules in succession by selecting Instagram on the application selection bar 330 and swiping left and/or right on the capsule selection bar 320 to display the Instagram feeds of each selected capsule in the content window 310. Similarly, a user may select YouTube as an application or function on the application selection bar 330 and scroll through the capsules on the capsule selection bar 320 in order to visualize the YouTube feeds for each selected capsule in the content window 310.

The content window 310 serves to display the content of a capsule selected by a combination of capsule selection bar 330 and the application selection bar 320. Thus, the content window is configured to display a variety of data and media. The content window 310 may display text, a web page, one or more photos, videos, documents, messages, or any other information required by the selected application. In some embodiments, the content window 310 may serve as a wrapper for the selected application. The content window 310 may comprise a plugin for displaying the content of a selected application (e.g., a YouTube plugin to display YouTube videos.) The content window 310 may be scalable, and may be expended to full screen and shrunk back to the content window by touching or clicking an expansion button provided on the window.

The process of editing a capsule 100 is similar to the process of adding a capsule during the creation of the capsule. In particular, an interface for editing a capsule may be opened by the capsule application in response to a predetermined user input. The interface for editing a capsule may resemble the interface 260 for creating a capsule illustrated in FIG. 5. In particular, the capsule application 250 may display sections of capsule data on a screen of the client computing device 200 for the user to alter.

Access to sections 265 may be subject to the restrictions placed on the capsule 100 by the owner of the capsule. For example, only certain sections 265 and data elements of the capsule may be available for editing by users other than the owner. In addition, a user may also be provided with the capability of editing certain sections of capsule 100 while browsing the capsule and without having to access a separate interface for editing.

An exemplary process for adding content to or editing a capsule is described from the perspective of client computing device 200 hosting a capsule management application 250 and part of system 400, previous described. The addition of content to a capsule 100 may be initiated from the main interface 300, for example by pressing an edit button provided on the main interface 300. Pressing such a button would initiate the editing process for the capsule currently being displayed by the main interface 300. In some embodiments, a user may initiate a search for content associated with the subject of the capsule 100. The search may be initiated from a search bar, button, or other interface element provided on the main interface 300 or on the edit screen 260. For example, a search button may be configured in simply initiate a search for relevant information about the present capsule 100 without needing to specify the type of information in a search bar. When the search is initiated, the contact management application 250 causes the client computing device 200 to transmit the search terms across network 420 to the provider server 410. The provider server 410 may conduct the search on Internet (or other public and private networks to which the provider server 410 has access) and return relevant results (i.e., links to content related to the object of the capsule 100 being viewed on the main interface 300). The search results may be displayed by the capsule software 250. Upon selection of a particular search result, the contact application 250 may ask the user confirmation for whether to add the link to the capsule 100 (in some embodiments the link may be added without confirmation). For example, actuating a search button on the main interface 300 or edit screen 260 may cause links to the Facebook, Instagram, and YouTube feeds of the capsule being viewed by the contact software 250 to be listed by the software. When one of the links (e.g., YouTube) is selected, the contact application 250 adds the link to a data field of the contact file and associate the data field to the application (e.g., the YouTube app) corresponding to the link, as previously described in this disclosure. The process of searching for and seamlessly integrating relevant information on the internet with the press of a few buttons in the same application 250 that displays the capsule 100 presents a significant improvement over existing processes for supplying relevant information to a contact card that require a user to search in a different application (e.g., a conventional web browser displaying a search engine) for relevant information to copy and paste into a contact application.

In some embodiments, when an owner of a capsule 100 edits data in his local capsule on a client computing device 200, the edit is synchronized with the server's copy of the capsule 100, which reflects the change in the local capsule. Further, the changed data is pushed to other local copies of the capsule on client devices 200. In this way, all copies of a capsule may be synchronized with changes made by the owner of the capsule. For example, a band whose capsule 100 contains a calendar of tour dates may add a new date to the calendar on their local copy of their capsule using the capsule application. The capsule application 250 stores the new tour date in the local capsule and transmits the updated calendar to the server 410 hosting the band's capsule. The server 410 updates the server's copy of the band's capsule with the new calendar, thus synchronizing the server's copy of the capsule with the local capsule 100 on the band's client device 200. The server 410 subsequently pushes the updated calendar to the band's capsules on fans' client devices 200. Notifications of the update may be provided by the capsule applications on the fans client's devices.

A capsule 100 may be published by its owner, which means it may be made publicly accessible to other users. Publication of a capsule 100 may be enabled in the capsule application 250 on a client computing device 200. When a capsule 100 is selected to be published, the capsule application 250 on the client device 200 may transmit changes in access permissions on the local capsule 100 to the capsule hosted on the server. The server may make the capsule available to search engines, for example. In particular, information contained in the capsules that are pushed to the server 410 for publication may be indexed for full-text search capability, enabling discovery of capsules by searching for any part of the capsule information. In some embodiments the content behind the links is indexed and further provides a deep search capability for not only the capsule content but also any information referenced by the capsule. In another embodiment the search capabilities for various topics are relegated to the search services of choice, enabling the search to act as a meta-search for the selected search providers. Any change to the capsule content that is pushed to the server 410 automatically triggers re-indexing of the modified capsule information. Scheduled automated processes are utilized to search for updates to publicly accessible information referenced by the capsules including possible changes to contact information, work information or other public information about a contact or topic specific information such as new songs, media available for an artist for example.

A capsule 100 created and/or owned by a user can be shared with other users (client computing devices 200). A capsule may be shared by transmitting a local copy of the capsule from a first client computing device 200 to a second client computing device 200. The copy may be transmitted through a variety of means. For example, the copy of the capsule 100 may be sent as an attachment via email or other messenger application running on the client computing devices 200. A capsule 100 may also be shared by transmitting a link to the capsule stored on a server from a first client computing device 200 to a second client computing device. When the link to the capsule 100 is accessed from the second client computing device, the second client computing device may transmit a request for capsule data from the server 410, which may in response deliver capsule data to the second client computing device.

A capsule 100 may be shared from the capsule application 250 on a client computing device 200. In an exemplary application, a share button or icon disposed on the main window 300 opens up a new interface for sharing that capsule. The capsule application displays a QR code on the main window 300 of the sharing interface. The QR code may be scanned by a second client device to obtain a link to the capsule and/or enable the capsule application 250 on the second client device to transmit a request to the server 410 for downloading the capsule to the second client device. Additionally, icons enabling sharing via various applications are also provided (e.g., iOS messenger, FB messenger, email, twitter, etc.). Similarly, the link to the capsule can be shared using near field communication means and/or Bluetooth, whereby the sender publishes a publicly accessible code for discovery for nearby devices, and scan for the published code enables the receiving devices to discover a publicly accessible link for the capsule. A capsule 100 may be shared using other applications or sharing functions of the client computing device 200 that that enable data transmission from the client computing device.

In some embodiments, the capsule software on the server 410, the capsule application 250 on the client computing device 200, or both, may be configured to save prior iterations of a capsule, or a record of modifications to the capsule that enables either application to restore a previous version of the capsule 100. The contact 100 can include time records associated with elements of the contact file to form a timeline. In particular, the record of changes can be used to generate timelines for various elements of the capsule or for the capsule as whole, and to graphically display for example when certain elements were added to the capsule 100. The capsule software 250 may provide an option for accessing one or more previous versions of a capsule 100. In addition to the traditional backup utility offered by this functionality (e.g., to recover deleted information from the capsule), access to previous versions of a capsule enables a user to create a new capsules based on previous version of a capsule 100, if required.

Social media platforms (e.g., illustrated in FIG. 4 as external services 430) provide access to other people's profiles but they are not known to be configured to provide downloadable contact files 100 using the other people's profiles. Websites can include a large array of information and often times include contact details including links (individual icons) to that company or individual's social media accounts. The contact details for such platforms are not downloaded files compatible as a contact file. Websites sometimes include a link for downloading a file but this typically limited. In some embodiments of the present invention, the system 400 of the present invention can enable an administrator of a website or social media page to package multiple contact details and links to disparate communication platforms into a single downloadable contact file or capsule 100 and provide the capsule 100 in an online directory.

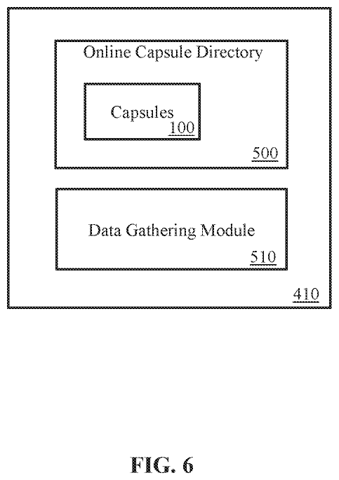

Embodiments of the present invention provide an online contact directory and delivery service 500. FIG. 6 illustrates a representation of an online contact directory and delivery service 500 implemented on a server 410 according to an embodiment of the present invention. In general, it should be understood that the service involves one or more servers 410 (e.g., such as a cloud comprising servers and supporting infrastructure). A software application (in non-transitory medium) is implemented on the system 400 (and in particular, on server 410, in some embodiments) to configure the system 400 to provide features and functionality described herein.

The service 500 is preferably configured to be public such that for example access to viewing the contacts or capsules 100 does not require a login/password or enrollments. The service 500 is preferably configured to be public by implementing access to contacts 100 of individuals irrespective of employer, association, or designated affiliation. The service 500 is configured to be a public directory, e.g., such that the Internet is configured to provide a public network of web sites as part of the World Wide Web. The service 500 is configured to allow individual in the public to create and store a contact on the service 500 through a website (using a browser) or through a mobile application. The service 500 can be configured to operate in cooperation with a software process, module, routine, or algorithm 510 that automatically find individuals and creates a contact on the service 500 for each individual. The algorithm 510 can be configured to automatically perform data gathering over the Internet (e.g., crawl sites or platforms) or other public databases or resources, and collect identities of objects associated contact information. The algorithm 510 can be configured to review the collected identities and associated contact information and create a contact or capsule 100 after performing processes that remove redundancies or distinguish similar identities based on associated contact information (e.g., two people with the same name would have different contact details). The service 500 can be configured to communicate to individual identities using the collected contact information and request that the individual approve or edit the contact information. The service 500 can also enable the individual to select whether to make the contact or capsule 100 accessible to all (the public) who access the service.

The service 500 is configured to allow an individual to create and store on the system 400 different contact cards or capsules 100 (each correspond to a contact file). This permits the creator or owner of the contact to control the information and level of access provided by each contact card 100 (e.g., a celebrity may not want to provide access to their personal telephone number to everyone and can have a special card that is saved and the service is configured to provide access to that card only in accordance with instruction specified by the creator). This control could also be at the data field level if desired. The service 500 can use authentication procedures such as a biometric signature (fingerprint, face, voice, retina, etc.) to verify an individual to create and edit a contact (and therefore corresponding contact file) on the service.

The service 500 can also verify users such as a celebrity through additional techniques. Contact files 100 that have been approved or created by the individual (the actual individual) who is the subject of the contact can include a security code or data that specifies that the file is verified and is therefore authentic (authenticated to be for the individual that is the subject of the contact file). The code can be an encrypted code that is generated from the identity or a security code designated for the individual or that particular contact (contact file 100 for that individual) and additional information such as the identity or code information of the individual or device that downloaded the contact file from the service. Other information such as the control of the contact file 100 (e.g., a checksum) can be incorporated into the encrypted code. A downloaded contact file 100 can be transmitted or shared with others. The service 500 can communicate with the device 200 of the user that received the contact file 100 (e.g., via an automated link when the recipient opens a contact file) and receive the encrypted code through the communication. The service 500 can then determine that the recipient received the contact file 100 from another user and can take action in response. A communication can be sent that visually indicates that the contact file 100 is not authentic. A communication can be sent that prevents the use of or blocks the contact information in the contact card 100. The encrypted code can serve another purpose such as to be checked to credit the individual that shared the contact for distributing the contact file 100. The individual who received the shared contact can seek to receive similar credit and may select an option that is provided with the service to update the file 100 with the encrypted code that is based on that individual's information such as their identity.

Preferably, the system 400 is configured to allow a user to select a contact file 100 from the directory or service 500. In response, the contact file 100 is downloaded to the user's computing device 200 and is automatically added to the user's contact (e.g., by the supporting application 250). In some embodiments, the service and/or the contact application 250 may substantially only or only require the user to select to save the contact file 100 on the device 200 and as a result add it to the contact on that device 200.

The term capsule is thus used herein to communicate that a contact stored as a contact file 100 of embodiments of the present invention is not limited to individuals or companies, but can include other objects such as best beaches, top ten financial applications, or touring schedules, and to communicate that the capsule 100 provides a form of messaging and distribution of material in static and dynamic ways (e.g., a band can create individual capsule for an upcoming concert and send it directly to their contact or upload to the server 410 for distribution and the content of the capsule can include for example links to sources to social media sites that provide additional and/or variable content as time passes if desired).

Further, the system described herein provides features for receiving disparate types of data from difference sources (e.g., an attachment from the client computing device, links and files from external services 430 such as social media feeds or various online databases) and performs operations to maintain and provide such data in a format standardized within the contacts application 250 and present the received for viewing and interaction in a standardized graphical user interface of the same application 250. Further, the system and in particular the contacts application 250 is configured to convert the received data to other formats for further distribution through existing applications such as a standard contract format. Thus, a user of the client computing device 200 (e.g., a mobile device) is able to package multiple types of content into a single capsule for delivery to a different client computing device that can present the multiple types of content of the capsule in standardized graphical user interface.

Each of the system, server, computing device, and computer described in this application can be implemented on one or more computer systems and be configured to communicate over a network. In one embodiment, the computer system includes a bus or other communication mechanism for communicating information, and a hardware processor coupled with bus for processing information.

The computer system also includes a main memory, such as a random access memory (RAM) or other dynamic storage device, coupled to bus for storing information and instructions to be executed by a processor of the computer or computing device. Main memory also may be used for storing temporary variables or other intermediate information during execution of instructions to be executed by a processor. Such instructions, when stored in non-transitory storage media accessible to processor, configure the computer system into a special-purpose machine that is customized to perform the operations specified in the instructions and provide or be capable of features and functionality described herein.

The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as an LCD, for displaying information to a computer user. An input device, including alphanumeric and other keys, may be coupled to bus for communicating information and command selections to processor. Another type of user input device is cursor control, such as a mouse, a trackball, touchscreen (e.g., on mobile phones) or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which in combination with the computer system causes or programs computer system to provide specialized features. According to one embodiment, the techniques herein are performed by the computer system in response to the processor executing one or more sequences of one or more instructions contained in main memory. Such instructions may be read into main memory from another storage medium, such as storage device. Execution of the sequences of instructions contained in main memory causes the processor to perform the process steps described herein. In alternative embodiments, hard-wired circuitry may be used in place of or in combination with software instructions.

The term storage media as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid state drive of a remote computer. A bus carries the data to main memory, from which processor retrieves and executes the instructions. The instructions received by main memory may optionally be stored on storage device either before or after execution by the processor.

The computer system also includes a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface, which carry the digital data to and from the computer system, are example forms of transmission media.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It should be understood that variations, clarifications, or modifications are contemplated. Applications of the technology to other fields are also contemplated.

Exemplary systems, devices, components, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It is understood from the above description that the functionality and features of the systems, devices, components, or methods of embodiments of the present invention include generating and sending signals to accomplish the actions.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope of the present invention.

What is claimed is:

1. A system for storing and managing contacts, the system comprising:
a contact management application installed on a client computing device, the client computing device including microprocessor and volatile and non-volatile memory to configure the client computing device, the contact management application configured to process a plurality of contact files, and configured to:
store contact data associated with a subject into a contact file, the contact data comprising a first set of data fields compatible with a standard contacts application and a second set of data fields compatible with the contact management application, one or more data fields being respectively associated with a corresponding application capable of operating on the client computing device; and
provide a visual interface on the client computing device comprising a content area, a contact file selection menu for selecting a contact file of the plurality of contact files, and an application selection menu for selecting one of the applications associated with the content of the contact file, and in response to the selection of the application display in the content area content associated with corresponding data fields from the selected contact file,
wherein the contact management application provides a user interface on the client computing device for selecting or inputting content data into the contact management application for storage into the contact file, and
wherein the client computing device further includes a network connection interface that allows the client computing device to communicate with another computer system over a network, and the contact management application being configured to transmit a selected contact file to the other computer system.

2. The system for storing and managing contacts of claim 1, wherein the first set of data fields is compatible with the VCF standard.

3. The system for storing and managing contacts of claim 1, wherein the contact file is structured to enable standard contact applications to open the contact file to access the first set of data fields.

4. The system for storing and managing contacts of claim 1, wherein the contacts management application is configured to be able to open, edit, and save a standard contact file having a standard contact file structure.

5. The system for storing and managing contacts of claim 1, wherein the contact file is a dynamic contact file in which the one or more data fields comprise a link to content stored on a remote server and updates to the stored content are displayed by the selected application.

6. The system for storing and managing contacts of claim 1, wherein the contact management application is configured to select and add a media file to the contact file, the application being configured to upload the selected media file to a server associated with the application, create a link to the location of the uploaded media file on the server, and include the link in the one or more data fields of the contact file.

7. The system for storing and managing contacts of claim 1, wherein the contact management application generates a modified link for content stored on a remote server, the modified link being configured to include security or personalization data that restricts the content to specific users.

8. The system for storing and managing contacts of claim 1, wherein the contact file can be saved as an icon on a lock screen or home screen of the client computing device and the content of the contact file can be displayed by a general viewer application, the contact file operating as a portal between that provides the general viewer with the content.

9. A system for storing and managing capsules for content associated with a subject, comprising:
a processor configured to acquire computer readable instructions stored in one or more memory devices and execute the instructions to:
process content stored in a capsule and related to the subject, the content comprising sets of identification data and having one or more applications associated with the content;
provide a visual interface comprising a content area configured to display content, a capsule selection menu configured to enable the selection of a capsule, and an associated application selection menu configured to enable the selection of an application; and
display in the content area of the interface, selected content associated with a selected one of the capsules and a selected application.

10. The system for storing and managing capsules of claim 9, wherein the visual interface is provided by a capsule management application configured to open the capsule, edit the capsule, and display content from the capsule.

11. The system for storing and managing capsules of claim 10, wherein the capsule management application is configured to read, display, and edit a standard contacts file and is further configured to convert the standard contact file into a capsule.

12. The system for storing and managing capsules of claim 9, wherein the processor is a processor of a client computing device and the system further comprising a server in communication with the client computing device over a network and configured to store the content of the capsule.

13. The system for storing and managing capsules of claim 9, wherein the capsule selection menu and the application selection menus comprise scrollable menus and scrolling through the capsule selection menu updates the content area with content from the selected capsules associated with the selected application, and scrolling through the application menu updates the content area with the selected applications associated with a selected capsule.

14. The system for storing and managing capsules of claim 9, wherein the capsule comprises a data structure, a database entry, or one or more files.

15. The system for storing and managing capsules of claim 9, wherein the capsule comprises a section that can be read and edited by a standard contacts application.

16. The system for storing and managing capsules of claim 9, wherein the content further comprises documents, media, or links to documents and media and the one or more applications are configured to open the documents, media, or links.

17. The system for storing and managing capsules of claim 9, wherein the processor is further configured to execute the instructions to transmit a copy of the capsule to another computer system over a network, and before transmission to restrict access to the content of the transmitted capsule on the other computer system to certain of the one or more applications associated with the content.

18. A method for storing and managing capsules comprising:
processing content stored in a capsule and related to the subject, the content comprising sets of identification data and having one or more applications associated with the content;
providing a visual interface comprising a content area configured to display content, a capsule selection menu configured to enable the selection of a capsule, and an associated application selection menu configured to enable the selection of an application; and
displaying in the content area of the interface, selected content associated with a selected one of the capsules and a selected application.

19. The method for storing and managing capsules of claim 19, wherein the capsule selection menu and the application selection menus comprise scrollable menus and scrolling through the capsule selection menu updates the content area with content from the selected capsules associated with the selected application, and scrolling through the application menu updates the content area with the selected applications associated with a selected capsule.

20. The method for storing and managing capsules of claim 19, wherein the capsule comprises a section that can be read and edited by a standard contacts application.

21. A public contact directory system, comprising:
a server that is configured to be accessible to the public via the :Internet or other network connections and is configured to store contact files for individuals or other objects and is configured to allow individuals to download individual contact files to client devices for their use and editing on their computer and is configured for contact files on the server to be claimed or verified by the individual that is the subject of the contact file, wherein the server is further configured to communicate with the client devices to modify access to and the content of the downloaded contact files.
